(19) United States
(12) Patent Application Publication
(10) Pub. No.: US 2015/0095993 A1
(43) Pub. Date: Apr. 2, 2015

(54) METHOD AND APPARATUS FOR PREVENTING THEFT OF PERSONAL IDENTITY

(71) Applicant: ELECTRONICS AND TELECOMMUNICATIONS RESEARCH INSTITUTE, Daejeon-city (KR)

(72) Inventors: Sohee PARK, Daejeon (KR); Hansung LEE, Daejeon (KR); Sunguk JUNG, Daejeon (KR); Janghee YOO, Daejeon (KR)

(73) Assignee: ELECTRONICS AND TELECOMMUNICATIONS RESEARCH INSTITUTE, Daejeon-city (KR)

(21) Appl. No.: 14/448,055

(22) Filed: Jul. 31, 2014

(30) Foreign Application Priority Data
Oct. 2, 2013 (KR) 10-2013-0117714

(51) Int. Cl. H04L 29/06; G06N 5/04

(52) U.S. Cl. CPC H04L 63/0861; H04L 67/42; G06N 5/04
USPC 726/5

(57) ABSTRACT

A method and apparatus of preventing the theft of a personal ID are disclosed. The apparatus of preventing the theft of a personal ID includes an estimation unit, a gender similarity computation unit, an age similarity computation unit, a final similarity computation unit, and a theft check unit. The estimation unit estimates the gender and age of a user based on an image of the user. The gender similarity computation unit computes the similarity in gender based on input gender and the estimated gender. The age similarity computation unit computes the similarity in age using input age and the estimated age. The final similarity computation unit computes a final similarity using the similarity in gender and the similarity in age. The theft check unit determines whether or not a personal ID has been stolen based on the results of comparison between the final similarity and a reference value.

### CROSS-REFERENCE TO RELATED APPLICATION

This application claims the benefit of Korean Patent Application No. 10-2013-0117714, filed Oct. 2, 2013, which is hereby incorporated by reference in its entirety into this application.

### BACKGROUND OF THE INVENTION

1. Technical Field

The present invention relates generally to a method and apparatus for preventing the theft of a personal identity (ID) and, more particularly, to a method and apparatus that are capable of preventing the theft of a personal ID in real time by checking whether or not information about the personal ID of a user and information about the face of the user are identical with each other when the user requests personal ID authentication when giving his or her personal ID information online.

2. Description of the Related Art

In general, a method of preventing the theft of a personal ID has a strong post-checking characteristic in that if personal ID information (e.g., a resident registration number or a PIN number) is used online, notification that the personal ID information has been used is provided through the mobile phone or e-mail of a user who has registered with personal ID theft prevention service. This method has a limitation in terms of the fundamental prevention of the theft of a personal ID because a user whose ID has been stolen must check his or her mobile phone or e-mail and to perform post-processing.

Furthermore, if personal biometric information (e.g., a face, a fingerprint or the iris), together with personal ID information, is used in personal ID authentication, personal bio recognition information is stored in a medium, such as a specific server or an integrated circuit (IC) card and the personal bio recognition information is used whenever an authentication request is made by a corresponding user.

For example, U.S. Pat. No. 8,275,176 entitled “Method and Apparatus for User Authentication using Face Image” discloses technology in which feature vectors are extracted from a face image using a characteristic in which energy concentrates around specific transform coefficients and then user authentication is performed through the comparison in similarity between the extracted feature vectors and already registered feature vectors, thereby being capable of improving speed and accuracy using a minimum quantity of data resources.

If personal biometric information is used in personal ID authentication as described above, a privacy problem arises, and there is a risk in which personal bio recognition information is stolen and then used when the personal bio recognition information is lost.

### SUMMARY OF THE INVENTION

Accordingly, the present invention has been made keeping in mind the above problems occurring in the conventional art, and an object of the present invention is to provide a method and apparatus that are capable of preventing the theft of a personal ID in real time by checking whether or not information about the personal ID of a user and information about the face of the user are identical with each other when the user requests personal ID authentication using his or her personal ID information online

In accordance with an aspect of the present invention, there is provided a method of preventing the theft of a personal identity (ID), including receiving, by a personal ID theft prevention apparatus, a personal ID authentication request through a client terminal of a user; estimating the gender and age of the user based on an image of the user received along with the personal ID authentication request; computing the similarity in gender based on the gender of the user input by the user and the estimated gender of the user, and computing the similarity in age using the age of the user input by the user and the estimated age of the user; computing a final similarity using the similarity in gender and the similarity in age; and determining whether or not a personal ID has been stolen based on the results of comparison between the final similarity and a reference value, and blocking the theft of the personal ID.

Blocking the theft of the personal ID may include, if the final similarity is lower than the reference value, determining that the gender or age of the user input by the user is not identical with that of the user who has made the personal ID authentication request and thus determining that the personal ID authentication has failed.

Blocking the theft of the personal ID may include, if the final similarity is higher than or equal to the reference value, determining that the gender or age of the user input by the user is identical with that of the user who has made the personal ID authentication request.

Computing the final similarity may include computing the final similarity in gender after assigning a weight for gender to the similarity in gender; computing the final similarity in age after assigning a weight for age to the similarity in age; and computing the final similarity using the final similarity in gender and the final similarity in age.

The sum of the weight for gender and the weight for age may be 1.

In accordance with another aspect of the present invention, there is provided an apparatus of preventing the theft of a personal ID, including an estimation unit configured to estimate the gender and age of a user based on an image of the user received along with a personal ID authentication request through a client terminal of the user; a gender similarity computation unit configured to compute the similarity in gender based on the gender of the user input by the user and the estimated gender of the user; an age similarity computation unit configured to compute the similarity in age using the age of the user input by the user and the estimated age of the user; a final similarity computation unit configured to compute a final similarity using the similarity in gender and the similarity in age; and a theft check unit configured to determine whether or not a personal ID has been stolen based on the results of comparison between the final similarity and a reference value, and to block the theft of the personal ID.

The theft check unit, if the final similarity is lower than the reference value, may determine that the gender or age of the user input by the user is not identical with that of the user who has made the personal ID authentication request and thus determine that the personal ID authentication has failed.

The theft check unit, if the final similarity is higher than or equal to the reference value, may determine that the gender or age of the user input by the user is identical with that of the user who has made the personal ID authentication request.

The final similarity computation unit may compute the final similarity in gender after assigning a weight for gender to the similarity in gender, may compute the final similarity in age after assigning a weight for age to the similarity in age, and may compute the final similarity using the final similarity in gender and the final similarity in age.

The estimation unit may estimate the gender and age of the user by applying a gender recognition algorithm and an age recognition algorithm to the image of the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram schematically illustrating the configuration of an apparatus for preventing the theft of a personal ID according to an embodiment of the present invention;

FIG. 2 is a diagram illustrating personal ID theft prevention service using face information provided by the apparatus for preventing the theft of a personal ID according to an embodiment of the present invention;

FIG. 3 is a flowchart illustrating a method of preventing the theft of a personal ID according to an embodiment of the present invention;

FIG. 4 is a flowchart illustrating a method of computing the similarity in gender and the similarity in age according to an embodiment of the present invention; and

FIG. 5 is a flowchart illustrating a method of finally determining whether or not a personal ID has been stolen according to an embodiment of the present invention.

### DESCRIPTION OF THE PREFERRED EMBODIMENTS

Embodiments of the present invention are described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

A method and apparatus for preventing the theft of a personal ID according to some exemplary embodiments of the present invention are described in detail below with reference to the accompanying drawings.

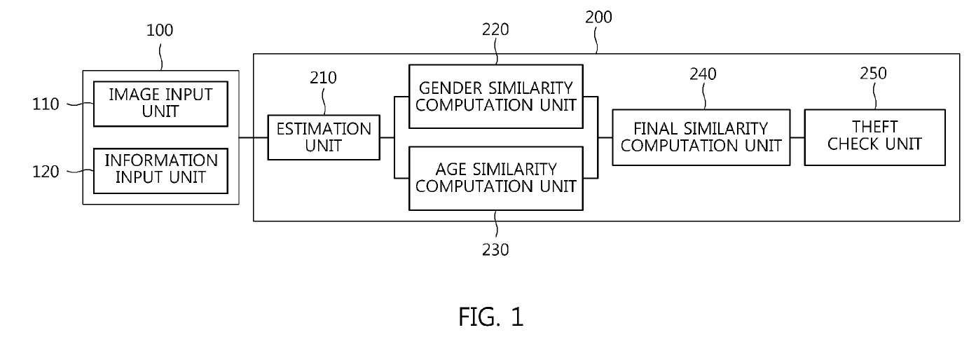

FIG. 1 is a diagram schematically illustrating the configuration of an apparatus for preventing the theft of a personal ID according to an embodiment of the present invention.

Referring to FIG. 1, the apparatus 200 for preventing the theft of a personal ID (hereinafter referred to as “the personal ID theft prevention apparatus 200”) operates in conjunction with the client terminal 100 of a user.

The user may request personal ID authentication from an authentication server online using the client terminal 100. In this case, the client terminal 100 sends an image, including the face of the user, and the user's personal information to the personal ID theft prevention apparatus 200 in real time.

For this purpose, the client terminal 100 may include an image input unit 110, and an information input unit 120.

The image input unit 110 receives results obtained by capturing an image of the face of the user using a photographing device, such as a camera.

The information input unit 120 receives personal information, such as the gender, age and date of birth of the user.

The personal ID theft prevention apparatus 200 may include an estimation unit 210, a gender similarity computation unit 220, an age similarity computation unit 230, a final similarity computation unit 240, and a theft check unit 250. Furthermore, when a user requests personal ID authentication using the client terminal 100 online, the personal ID theft prevention apparatus 200 receives an image of the face of the user and personal information from the user.

The estimation unit 210 estimates the gender and age of the user based on the image of the face of the user received from the client terminal 100. In this case, the estimation unit 210 may estimate the gender and age of the user by applying a gender recognition algorithm and an age recognition algorithm to the image of the face of the user. The algorithms used to recognize a face, such as the gender recognition algorithm and the age recognition algorithm, are not limited to specific algorithms.

The gender similarity computation unit 220 computes the similarity in gender using the gender of the user input by the user and the estimated value of the gender of the user estimated by the estimation unit 210.

The age similarity computation unit 230 computes the similarity in age using the age of the user input by the user and the estimated value of the age of the user estimated by the estimation unit 210.

The final similarity computation unit 240 computes the final similarity based on the similarity in gender computed by the gender similarity computation unit 220 and the similarity in age computed by the age similarity computation unit 230.

The theft check unit 250 compares the final similarity with a previously set reference value, and finally determines whether or not a personal ID has been stolen based on the results of the comparison.

If, as a result of the comparison, the final similarity is found to be higher than or equal to the reference value, the theft check unit 250 determines that the personal information provided by the user is identical with the user who has requested the personal ID authentication.

If, as a result of the comparison, the final similarity is found to be lower than the reference value, the theft check unit 250 determines that the personal information provided by the user is not identical with the user who has requested the personal ID authentication. That is, if the final similarity is lower than the reference value, the theft check unit 250 determines that the personal ID may have been stolen, and determines that the personal ID authentication has failed.

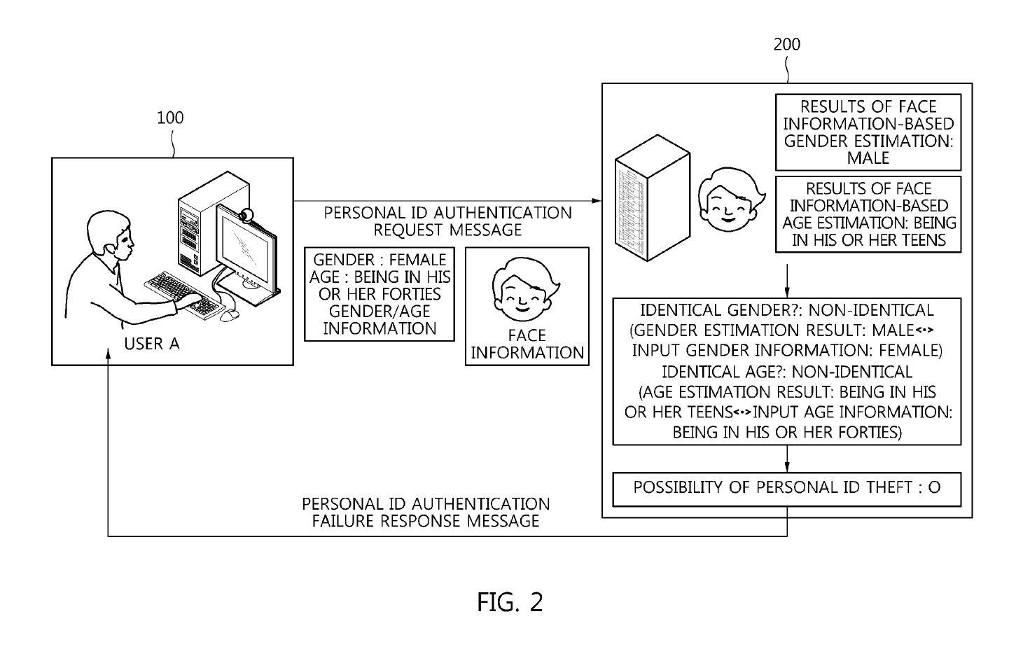

Personal ID theft prevention service using face information provided by the personal ID theft prevention service is described in detail below with reference to FIG. 2.

FIG. 2 is a diagram illustrating the personal ID theft prevention service using face information provided by the apparatus for preventing the theft of a personal ID according to an embodiment of the present invention.

Referring to FIG. 2, a user A requests personal ID authentication from an authentication server using the client terminal 100 online In this case, the authentication server includes the personal ID theft prevention apparatus 200, but the present invention is not limited thereto.

The user A sends an image of the face of the user and the user's personal information (e.g., information about gender and age) to the personal ID theft prevention apparatus 200 in real time using the client terminal 100. In this case, according to the user's personal information, the gender of the user A is female, and the user A is in his or her forties.

The personal ID theft prevention apparatus 200 estimates the gender and age of the user A using the image of the face of the user A. In FIG. 2, the gender of the user A has been estimated to be male, and the user A has been estimated to be in his or her teens. That is, the personal information (gender: female, and age: being in his or her forties) actually input by the user A is not identical with the estimated gender result (gender: male) and the estimated age result (age: being in his or her teens) using the face image that have been received in real time. In this case, the personal ID theft prevention apparatus 200 finally determines that the personal ID may have been stolen and sends a personal ID authentication failure response message to the user A through the client terminal 100.

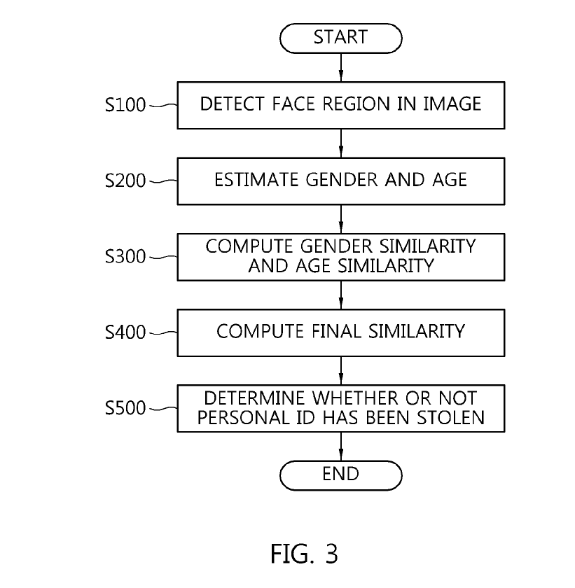

A method of preventing the theft of a personal ID is described in detail below with reference to FIG. 3.

FIG. 3 is a flowchart illustrating the method of preventing the theft of a personal ID according to an embodiment of the present invention.

First, the personal ID theft prevention apparatus 200 operates in conjunction with the client terminal 100 of a user, and receives a personal ID authentication request from the client terminal 100. In this case, the personal ID theft prevention apparatus 200 receives an image, including the face of the user, and the user's personal information from the client terminal 100 in real time.

Referring to FIG. 3, when the personal ID authentication request is received, the personal ID theft prevention apparatus 200 detects a face region in the image received along with the personal ID authentication request at step S100.

At step S200, the personal ID theft prevention apparatus 200 estimates the gender and age of the user using the face region detected at step S100. In this case, the personal ID theft prevention apparatus 200 may estimate the gender and age of the user by applying a gender recognition algorithm and an age recognition algorithm to the face region detected at step S100. In this case, the algorithms used to recognize a face, such as the gender recognition algorithm and the age recognition algorithm, are not limited to specific algorithms.

At step S300, the personal ID theft prevention apparatus 200 computes the similarity in gender using the gender of the user input by the user and the gender of the user estimated at step S200, and computes the similarity in age using the age of the user input by the user and the age of the user estimated at step S200.

At step S400, the personal ID theft prevention apparatus 200 computes the final similarity based on the similarity in gender and the similarity in age computed at step S300.

At step S500, the personal ID theft prevention apparatus 200 compares the final similarity, computed at step S400, with a previously set reference value and finally determines whether or not the personal ID has been stolen based on the results of the comparison.

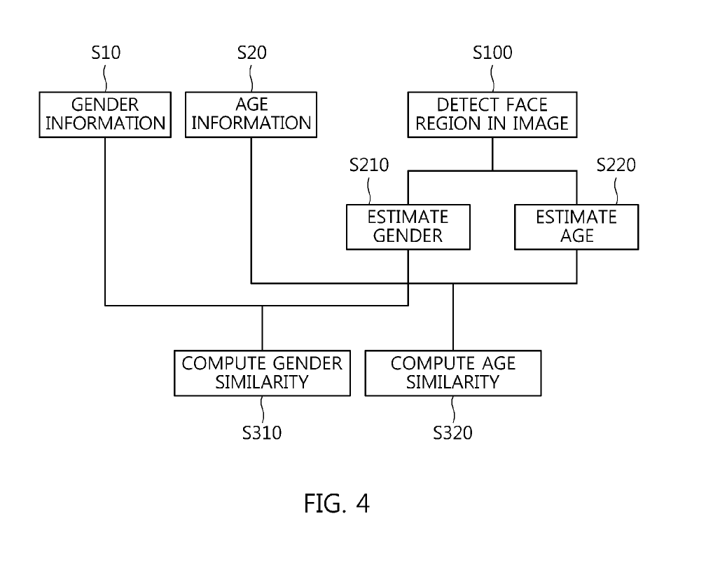

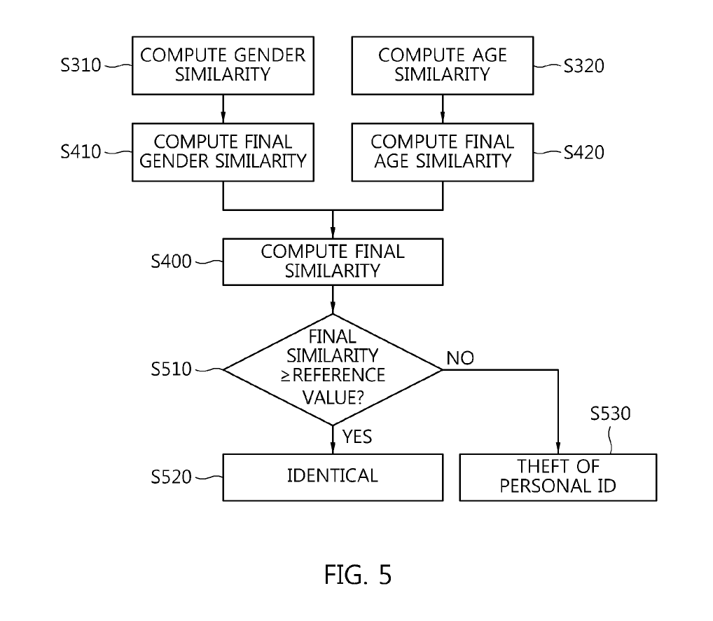

A method of computing the similarity in gender and the similarity in age and a method of finally determining whether or not a personal ID has been stolen are described in detail below with reference to FIGS. 4 and 5.

FIG. 4 is a flowchart illustrating the method of computing the similarity in gender and the similarity in age according to an embodiment of the present invention.

Referring to FIG. 4, when a personal ID authentication request is received from the client terminal 100, the personal ID theft prevention apparatus 200 receives user's personal information from a user.

More specifically, the personal ID theft prevention apparatus 200 receives information about the gender of the user and information about the age of the user at steps S10 and S20.

Furthermore, when the personal ID authentication request is received, the personal ID theft prevention apparatus 200 detects a face region in an image received along with the personal ID authentication request at step S100.

At step S210, the personal ID theft prevention apparatus 200 estimates the gender of the user using the face region detected at step S100 and a gender recognition algorithm. Furthermore, at step S220, the personal ID theft prevention apparatus 200 estimates the age of the user using the face region detected at step S100 and an age recognition algorithm.

At step S310, the personal ID theft prevention apparatus 200 computes the similarity in gender using the information about the gender of the user received at step S10 and the gender of the user estimated at step S210.

Furthermore, at step S320, the personal ID theft prevention apparatus 200 computes the similarity in age using the information about the age of the user received at step S20 and the age of the user estimated at step S220.

FIG. 5 is a flowchart illustrating the method of finally determining whether or not a personal ID has been stolen according to an embodiment of the present invention.

Referring to FIG. 5, the personal ID theft prevention apparatus 200 computes the similarity in gender and the similarity in age at steps S310 and S320, as described in conjunction with FIG. 4.

The personal ID theft prevention apparatus 200 assigns a weight for gender to the similarity in gender and computes the final similarity in gender at step S410. Furthermore, the personal ID theft prevention apparatus 200 assigns a weight for age to the similarity in age and computes the final similarity in age at step S420. In this case, the sum of the weight for gender and the weight for age is 1. That is, if one of gender information and age information is used, the weight is 1.

At step S400, the personal ID theft prevention apparatus 200 computes the final similarity using the final similarity in gender computed at step S410 and the final similarity in age computed at step S420.

The personal ID theft prevention apparatus 200 checks whether or not the final similarity is higher than or equal to a previously set reference value at step S510.

If, as a result of the comparison, the final similarity is found to be higher than or equal to the previously set reference value, the personal ID theft prevention apparatus 200 determines that personal information provided by the user is identical with a user who has requested personal ID authentication at step S520.

If, as a result of the comparison, the final similarity is found to be lower than the previously set reference value, the personal ID theft prevention apparatus 200 determines that the personal information provided by the user is not identical with the user who has requested the personal ID authentication. That is, if the final similarity is lower than the reference value, the personal ID theft prevention apparatus 200 determines that the personal ID authentication has failed because there is a possibility of a personal ID having been stolen at step S530.

As described above, the method and apparatus for preventing the theft of a personal ID according to the embodiments of the present invention can prevent the theft of a personal ID in real time by checking whether or not information about the personal ID of a user and information about the face of the user are identical with each other when the user requests personal ID authentication using the personal ID information online

Furthermore, the present invention can guarantee the privacy of personal biometric information and also prevent the theft of a personal ID in real time by checking whether or not personal ID information is identical with personal face information in real time without storing the personal face information in a specific server or a medium.

Furthermore, the present invention can prevent the theft of other persons' IDs in advance using various types of online personal ID authentication service, such as personal ID authentication in a gaming service and personal ID authentication in a social network service (SNS).

Furthermore, the present invention can prevent the theft of an adult ID, for example, when a minor accesses various types of adult content using adult ID information in adult authentication.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of preventing a theft of a personal identity (ID), comprising:
receiving, by a personal ID theft prevention apparatus, a personal ID authentication request through a client terminal of a user;
estimating gender and age of the user based on an image of the user received along with the personal ID authentication request;
computing a similarity in gender based on gender of the user input by the user and the estimated gender of the user, and computing a similarity in age using age of the user input by the user and the estimated age of the user;
computing a final similarity using the similarity in gender and the similarity in age; and
determining whether or not a personal ID has been stolen based on results of comparison between the final similarity and a reference value, and blocking the theft of the personal ID.

2. The method of claim 1, wherein blocking the theft of the personal ID comprises, if the final similarity is lower than the reference value, determining that the gender or age of the user input by the user is not identical with that of the user who has made the personal ID authentication request and thus determining that the personal ID authentication has failed.

3. The method of claim 1, wherein blocking the theft of the personal ID comprises, if the final similarity is higher than or equal to the reference value, determining that the gender or age of the user input by the user is identical with that of the user who has made the personal ID authentication request.

4. The method of claim 1, wherein computing the final similarity comprises:
computing a final similarity in gender after assigning a weight for gender to the similarity in gender;
computing a final similarity in age after assigning a weight for age to the similarity in age; and
computing a final similarity using the final similarity in gender and the final similarity in age.

5. The method of claim 4, wherein a sum of the weight for gender and the weight for age is 1.

6. An apparatus of preventing a theft of a personal ID, comprising:
an estimation unit configured to estimate gender and age of a user based on an image of the user received along with a personal ID authentication request through a client terminal of the user;
a gender similarity computation unit configured to compute a similarity in gender based on gender of the user input by the user and the estimated gender of the user;
an age similarity computation unit configured to compute a similarity in age using age of the user input by the user and the estimated age of the user;
a final similarity computation unit configured to compute a final similarity using the similarity in gender and the similarity in age; and
a theft check unit configured to determine whether or not a personal ID has been stolen based on results of comparison between the final similarity and a reference value, and to block the theft of the personal ID.

7. The apparatus of claim 6, wherein the theft check unit, if the final similarity is lower than the reference value, determines that the gender or age of the user input by the user is not identical with that of the user who has made the personal ID authentication request and thus determines that the personal ID authentication has failed.

8. The apparatus of claim 6, wherein the theft check unit, if the final similarity is higher than or equal to the reference value, determines that the gender or age of the user input by the user is identical with that of the user who has made the personal ID authentication request.

9. The apparatus of claim 6, wherein the final similarity computation unit computes a final similarity in gender after assigning a weight for gender to the similarity in gender, computes a final similarity in age after assigning a weight for age to the similarity in age, and computes a final similarity using the final similarity in gender and the final similarity in age.

10. The apparatus of claim 6, wherein the estimation unit estimates the gender and age of the user by applying a gender recognition algorithm and an age recognition algorithm to the image of the user.
